(19) United States
(12) Patent Application Publication
(10) Pub. No.: US 2009/0195542 A1
(43) Pub. Date: Aug. 6, 2009

(54) IMAGE PROCESSING APPARATUS

(75) Inventors: Osamu Kawamura, Osaka (JP); Yorihiko Wakayama, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/300,769

(22) PCT Filed: May 10, 2007
(86) PCT No.: PCT/JP2007/059692

§ 371 Date: Nov. 13, 2008

(30) Foreign Application Priority Data
May 16, 2006 (JP) 2006-136047

(51) Int. Cl. G06T 15/40

(52) U.S. Cl. 345/422

(57) ABSTRACT

In an image processing apparatus using a read buffer, in a case where access request target data is not stored in the read buffer, the read buffer is controlled such that data corresponding to a position having coordinates, which is most distant from a position having coordinates corresponding to the access request target data, is discarded or replaced. Consequently, the image processing apparatus increases the probability that data corresponding to a position close to a position corresponding to the access request target data remains in the read buffer. Accordingly, the hit rate of the read buffer is increased. Thus, the frequency of access to an external memory can be reduced.

### TECHNICAL FIELD

The present invention relates to a technique for reducing, when data stored in an external memory for a semiconductor device incorporating a processor is repeatedly used and processed in the semiconductor device, the number of times of access to the external memory by copying data stored in the external memory to a read buffer incorporated in the semiconductor device and by causing the processor to access the read buffer instead of accessing the external memory.

### BACKGROUND ART

In a case where processing is performed on a region (frame memory), in which image data of one screen is stored, using a processor, such as a central processing unit (CPU) or a digital signal processor (DSP), in an image data processing system, sometimes, pixel data to be processed and peripheral pixel data thereof are frequently referred to and updated. An apparatus is known, which is configured to use a memory incorporated into the same semiconductor device, in which the processor is provided, as a read buffer in order to reduce the number of times of access to a frame memory during performing image processing. A part of image data stored in the frame memory is stored in the read buffer. The processor processes image data on the read buffer. Upon completion of processing the image data, the data stored on the buffer is written back to the frame memory. Then, data for performing the next image data processing, which is stored in the frame memory, is newly stored in the read buffer.

The capacity of the read buffer is smaller than that of the frame memory. Thus, it is necessary for repeating image data processing to discard the data stored in the read buffer and to overwrite the discarded data with new data. A “least recently used” (LRU) method for discarding temporally oldest data is widely known as a conventional method for replacing data stored in an internal memory, which has been stored in an external memory, with new data. In addition to the LRU method, a method for causing data, which are present in the vicinity of each other in an address space, to remain in the read buffer (see, e.g., Patent Document 1) is also widely known. FIG. 4 illustrates an operation of a conventional buffer control apparatus described in Patent Document 1.

As illustrated in FIG. 4, first, in step 4001, an access request from a processor to an external memory is generated. Then, in step 4002, a high-order address (tag address) of an access target is recorded on a tag queue provided in the read buffer control unit. However, in a case where the tag address is the same as that recorded the last time, the tag address is not newly recorded thereon. Next, in step 4003, it is determined whether access target data is stored in the read buffer. If the access target data is stored, this data is read from the read buffer in step 4005. Then, the read data is transmitted to the processor in step 4006. If the access target data is not stored, one of the data stored in the read buffer is discarded. Then, access target data is newly stored in the read buffer. Hereunder, a method of determining data to be discarded is described. In the case of an example illustrated in FIG. 4, in step 4007, target data to be discarded is temporarily selected. In step 4008, it is checked by comparison whether the tag address corresponding to the selected target data is matched with the address recorded on the tag queue in step 4002. If matched, it is indicated that there is a history indicating that an area having the same high-order address as that of the target data selected by the LRU method in step 4007 has been accessed. Then, in step 4007, another target data to be discarded is selected again in the direction of making the selected target data remain in the read buffer. If target data to be discarded having a tag address, which is not included in the tag queue, is selected, access target data is read from the memory in step 4009. Then, in step 4010, the read data is transmitted to the processor. In addition, the location in the read buffer, from which the target data to be discarded is selected in step 4007, is overwritten with the read data.

Patent Document 1: Japanese Patent No. 3,438,598 (page 2 and 3, and FIG. 2)

### DISCLOSURE OF THE INVENTION

### Problems that the Invention is to Solve

However, in the aforementioned conventional apparatus, replacement target data in the read buffer is selected according to the high-order data. Thus, in a case where an image memory, to which image information is address-mapped in a two-dimensional manner like a frame memory, is an object to be accessed, the matching in the high-order address is not always correlated with the two-dimensional location of target data. Sometimes, data which is present in the vicinity of processing target data and is highly likely to be accessed in the near future, is discarded from the read buffer. Thus, the conventional apparatus has a problem in that an effect of reducing the frequency of access to an external memory is insufficient. This problem occurs not only in the case of address-mapping image information in a two-dimensional manner but in the case of performing the mapping of information including three-dimensional spatial information.

An object of the invention is to provide an image processing apparatus that more reduces the frequency of access to an image memory by controlling, when data stored in a read buffer is replaced, data in consideration of the two-dimensional or three-dimensional relation between processing target data and each data stored in the read buffer so as to discard data corresponding to a position having a large distance from a position corresponding to the processing target data.

### Means for Solving the Problems

In order to solve the aforementioned problems of the conventional apparatus, a read buffer control portion according to the invention is provided with a distance calculation portion configured to calculate a distance from a position having coordinates represented by access request target data to a position having coordinates represented by each data stored in a read buffer. The read buffer control portion has the function of selecting data which corresponds to the maximum calculated distance and is stored in the read buffer. The read buffer control portion replaces the selected data with the access request target data.

With this configuration, the image processing apparatus is enabled to allow data, which is present in the vicinity of currently processed data and is highly likely to be used in subsequent processing, to remain in the read buffer. Thus, the hit rate of data in the read buffer is increased. Consequently, the frequency of access to an external memory can be more reduced.

### ADVANTAGES OF THE INVENTION

According to an image processing apparatus of the invention, the frequency of access to an external memory in image processing using a read buffer can be reduced, as compared with the conventional apparatus.

### BRIEF DESCRIPTION OF THE DRAWINGS

FIG. 1 is a block diagram illustrating an image processing apparatus according to Embodiment 1 of the invention.

FIG. 2 is a block diagram illustrating an image processing apparatus according to Embodiment 2 of the invention.

FIG. 3 is a flowchart illustrating the flow of an operation of a read buffer access control portion in the image processing apparatus according to Embodiment 2 of the invention.

FIG. 4 is a flowchart illustrating the flow of an operation of a read buffer access control portion in a conventional image processing apparatus.

FIG. 5 is a diagram illustrating an example of an output image of the image processing apparatus according to Embodiment 1 of the invention.

FIG. 6 is a diagram illustrating an example of an output image of the image processing apparatus according to Embodiment 2 of the invention.

FIG. 7 is a diagram illustrating another example of an output image of the image processing apparatus according to Embodiment 2 of the invention.

### DESCRIPTION OF REFERENCE NUMERALS AND SIGNS

1001 processor
1002 image memory
1003 read buffer
1004 read buffer access control portion
1100 semiconductor device
2001 processor
2002 image memory
2003 read buffer
2004 read buffer access control portion
2005 distance calculation portion
2100 semiconductor device
5001 display screen
5002 coordinates of a position corresponding to access target data in the display screen
5003 coordinates of a position in the display screen, which corresponds to data stored in the read buffer and is most distant from the position that has the coordinates 5002 in the display screen and corresponds to the access target data
5004 coordinates of positions respectively corresponding to data stored in the read buffer
6001 display screen
6002 coordinates of a position corresponding to access target data in a predetermined region 6005
6003 coordinates of a position in the predetermined region 6005, which corresponds to data stored in the read buffer and is most distant from the position that has the coordinates 6002 in the predetermined region 6005 and corresponds to the access target data
6004 coordinates of positions respectively corresponding to data stored in the predetermined region 6005
6005, 6006 predetermined regions
7001 display screen
7002 spatial coordinates of a position corresponding to access target data in a predetermined region 7005
7003 spatial coordinates of a position in the predetermined region 7005, which corresponds to data stored in the read buffer and is most distant from the position that has the spatial coordinates 7002 in the predetermined region 7005 and corresponds to the access target data
7004 spatial coordinates of positions respectively corresponding to data stored in the predetermined region 7005
7005, 7006 predetermined regions

### BEST MODE FOR CARRYING OUT THE INVENTION

Hereinafter, embodiments of the invention are described with reference to the accompanying drawings.

### Embodiment 1

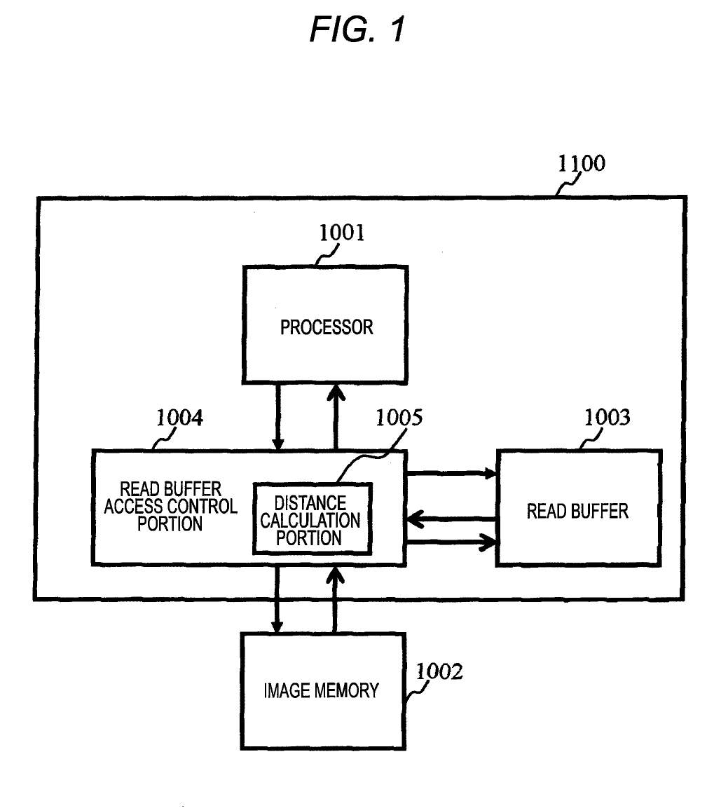

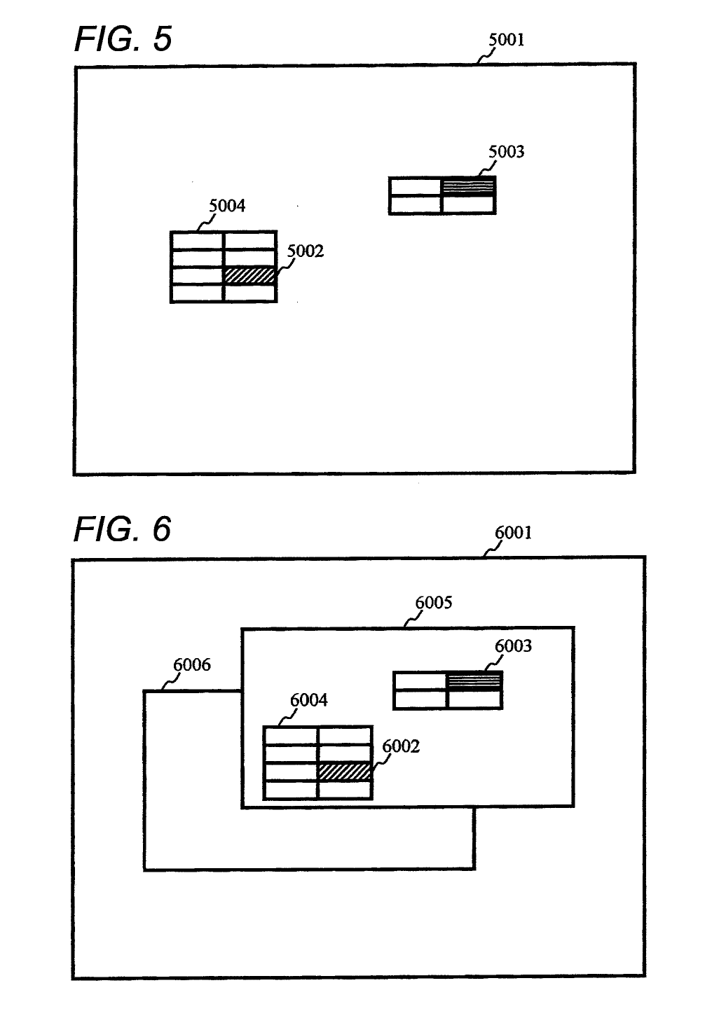

FIG. 1 is a block diagram illustrating an image processing apparatus according to Embodiment 1 of the invention. FIG. 5 is a diagram illustrating an example of an output image of the image processing apparatus according to Embodiment 1 of the invention.

In FIG. 1, reference numeral 1100 designates a semiconductor device into which the invention is introduced. Reference numeral 1001 denotes a processor for processing image data. Reference numeral 1002 represents an image memory serving as an external memory for the semiconductor device 1100. Reference numeral 1003 designates a read buffer which temporarily stores data to be stored in the image memory 1002 and to which the processor 1001 can refer instead of accessing the image memory 1002 when the processor 1001 performs image processing. Reference numeral 1004 denotes a read buffer access control portion that receives an access request for accessing image data, which is made by the processor 1001, and controls read buffer access as follows. That is, the read buffer access control portion 1004 reads, in a case where access request target data is stored in the read buffer 1003, this data from the read buffer 1003 and transmits the read data to the processor 1001. However, the read buffer access control portion 1004 reads, in a case where access request target data is not stored in the read buffer 1003, this data from the image memory 1002 and transmits the read data to the processor 1001. In addition, the read buffer access control portion 1004 causes also the read buffer 1003 to store the access request target data.

In FIG. 5, reference numeral 5001 designates a display screen. Reference numeral 5002 denotes a position, at which access request target data is displayed, on the display screen 5001. Reference numeral 5003 represents a position corresponding to image data, which is most distant from the position 5002 for displaying the access request target data, among positions at which image data stored in the read buffer 1003 are respectively displayed. Reference numeral 5004 designate positions, at which the image data stored in the read buffer 1003 are respectively displayed, on the display screen 5001 (the configuration of Embodiment 1).

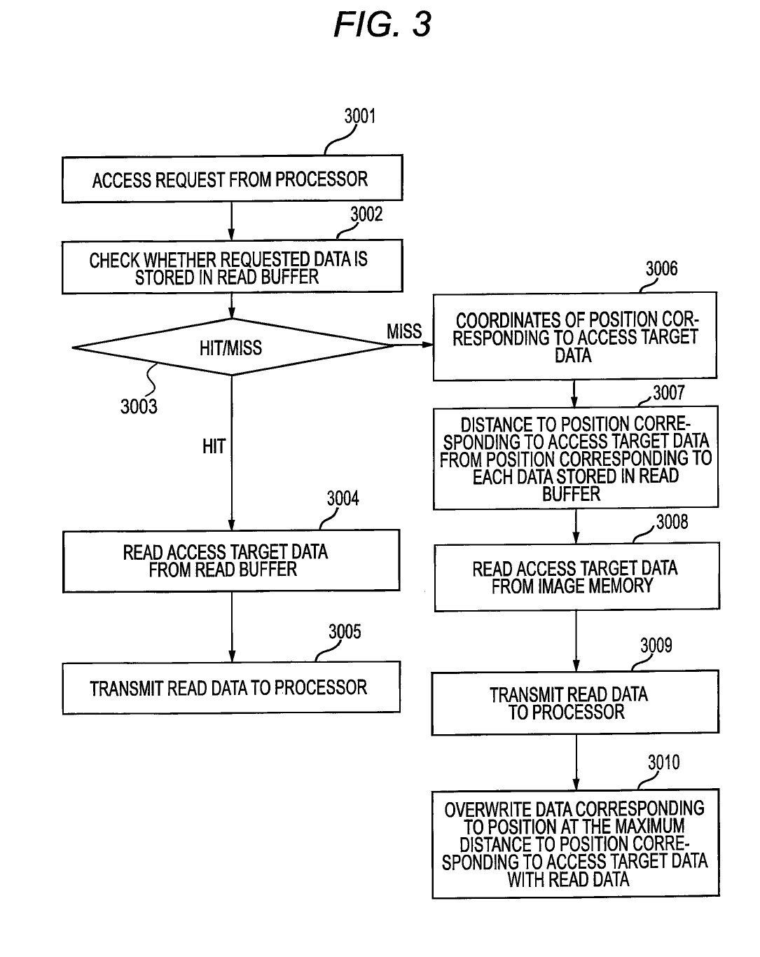

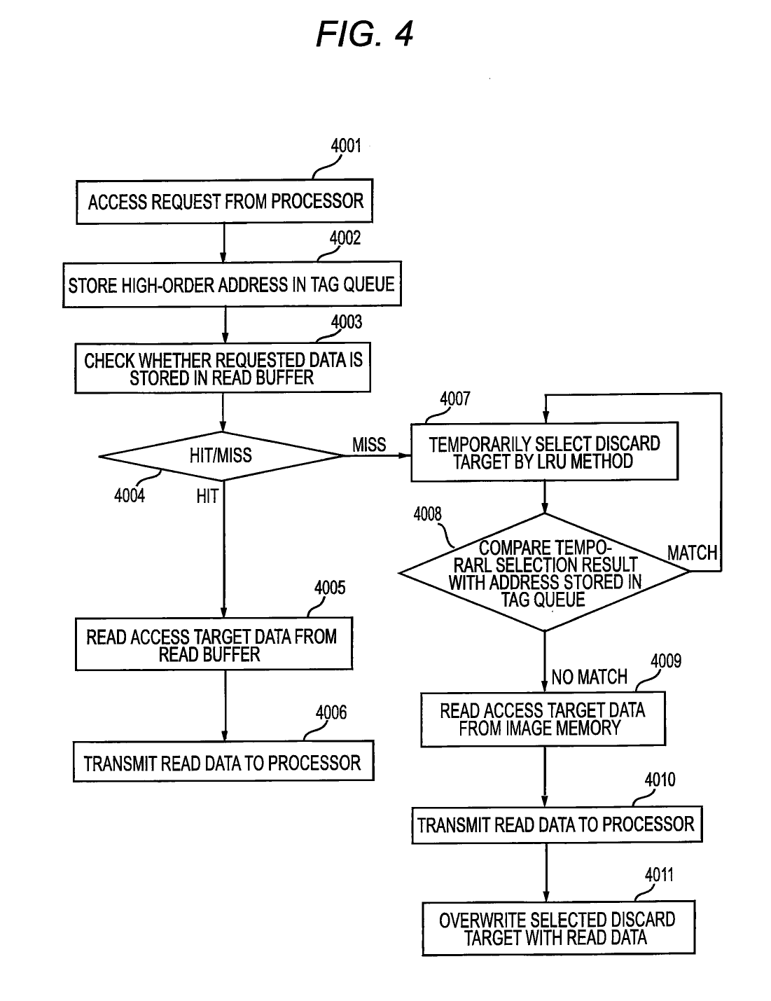

In FIG. 1, reference numeral 1005 designates a distance calculation portion for calculating the distance between a position having the coordinates corresponding to image data, the access to which is requested by the processor 1001, in the display screen 5001 and a position having coordinates, which correspond to each data stored in the read buffer 1003, in the display screen 5001. The read buffer access control portion 1004 receives a result of calculation performed by the distance calculation portion 1005 and controls read buffer access according to a flow illustrated in FIG. 3, which will be described in the following description of Embodiment 2.

With such a configuration, for example, in a case where the processor 1001 performs processing for generating character data, which represents shaded characters, using font data stored in the image memory 1002, it is necessary to repeatedly use the font data. However, only when the font data is first read from the image memory 1002, simultaneously, the read buffer access control portion 1004 can cause also the read buffer 1003 to store the font data. In a case where the processor 1001 refers to the font data at the second time or later, the data can be read from the read buffer 1003 instead of the image memory 1002 due to the action of the read buffer access control portion 1004, and can be then referred to by the processor 1001. Consequently, the frequency of access to the image memory 1002 can be reduced.

Incidentally, in the present embodiment, the image memory 1002 is provided as a storage device in which processing target data is stored. However, the storage device for storing the processing target data is not limited to a semiconductor memory. Storage media, such as an optical disk, a magnetic disk, and a magneto-optical disk, and a data storage connected via a network can be used as the storage device.

Further, the generation of character data representing a shaded character using font data has been described as an example of the image processing in the present embodiment. In addition, processing, such as expansion, shrinkage, rotation, inversion, and color conversion, can be performed as the image processing. Further, the data to be subjected to the image processing is not limited to font data. The processing of general image data, such as data representing a figure, and a photograph, can be performed as the image processing.

### Embodiment 2

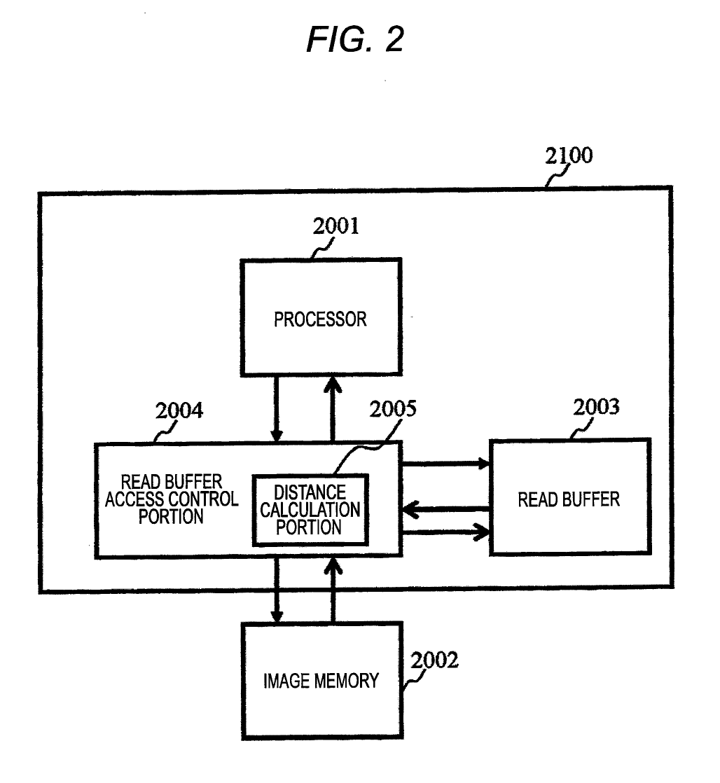

FIG. 2 is a block diagram illustrating an image processing apparatus according to Embodiment 2 of the invention. FIG. 3 is a flowchart illustrating an example of a process flow in a read buffer control unit of the image processing apparatus according to Embodiment 2 of the invention. FIG. 6 is a diagram illustrating an example of an output image of the image processing apparatus according to Embodiment 2 of the invention.

In FIG. 2, reference numeral 2005 designates a distance calculation portion for calculating the distance between a position having the coordinates corresponding to image data, the access to which is requested by the processor 2001, in a predetermined region of the display screen and a position having coordinates, which correspond to each data stored in the read buffer 2003, in the predetermined region of a display screen 6001. According to the present embodiment, the predetermined region of the display screen is, for example, regions represented by frames designated with reference numerals 6005 and 6006 in FIG. 6. A read buffer access control portion 2004 receives a result of calculation performed by the distance calculation portion 2005 and controls read buffer access according to the flow illustrated in FIG. 3.

As illustrated in FIG. 3, when the read buffer control unit receives an access request for acquiring processing data from the processor in step 3001, the read buffer control unit checks in step 3002 whether access request target data is stored in the read buffer. If it is found as a result of checking in step 3003 that the access target data is present (i.e., the access target data is hit) in the read buffer, the access target data is read from the read buffer in step 3004. Then, the read data is transmitted to the processor in step 3005. On the other hand, if it is found as a result of checking in step 3033 that the access target data is not present (i.e., the access target data is missed) in the read buffer, it is necessary to read the access target data from an image buffer in step 3008 and to transmit the read data to the processor in step 3009. It is also necessary to newly store the access request target in the read buffer in parallel to the transmission of the data to the processor. However, if no empty space in the read buffer, it is necessary to discard data already stored in the read buffer. This is because of the fact that generally, in a case where a processor refers to data in image processing, it is frequent to repeatedly refer to the same data, and that the probability of suppressing the occurrence of access to an image memory in the near future is increased by storing in the read buffer at least image data accessed most recently. Conversely, a problem is what data should be made to remain in the read buffer in order to suppress data replacement in future image processing. Incidentally, according to the embodiment illustrated in FIGS. 2 and 6, in step 3007, the apparatus determines a distance from a position having coordinates 6002 corresponding to access request target data, which is represented by image data to be processed, in the predetermined region 6005 of a display screen 6001 to a position having coordinates 6004 represented by each image data stored in the read buffer. Image data, which is stored in the read buffer and corresponds to a position 6003 having a largest distance from the position corresponding to the access request target data to be newly read this time, is searched for and is overwritten in step 3010. With this configuration, data which represents an image having a short distance from the position corresponding to the access request target data and is highly likely to be referred to by the processor in the future, can be prevented by performing data replacement on the data stored in the read buffer from being discarded. Consequently, the frequency of access to an external image memory can be reduced.

Incidentally, in the foregoing description of the present embodiment, the flow of processes has been presented, in which the access target data is read from the image memory after the distance calculation portion calculates the distance from the position having the coordinates 6002 corresponding to and represented by the access request target data in the predetermined region 6005 of the display screen 6001 to the position having the coordinates 6004 represented by each image data, which is represented by the data stored in the read buffer. However, such processes can be simultaneously performed in parallel to each other or can be performed in an inverse order.

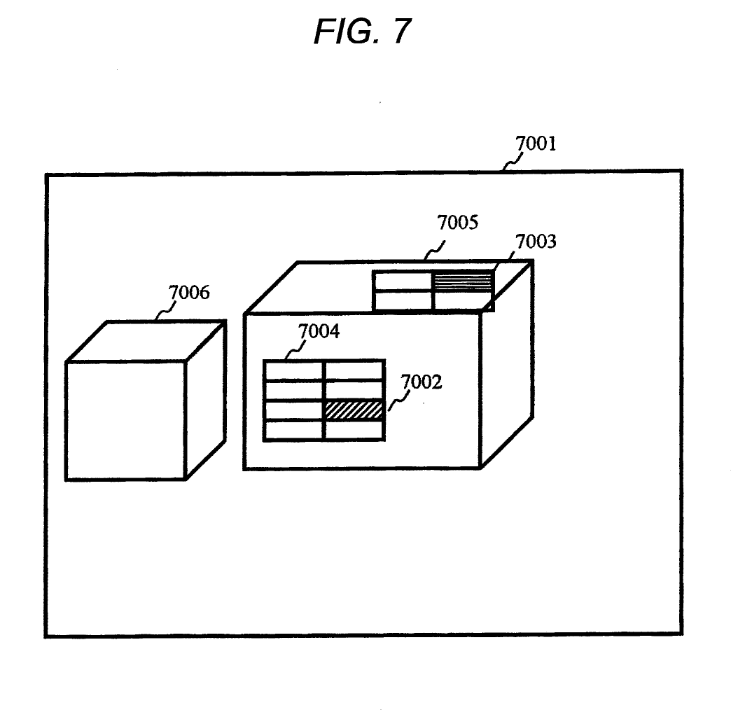

Further, coordinate information used in a control operation in the present embodiment can be either plane coordinate information used in the case of displaying image data on a plane or spatial coordinates used in the case of performing the stereoscopic display of image data. Further, the number of the predetermined regions in the display screen can be plural. Alternatively, the coordinate information can be that defined on a model in a case where a display object is modeled on the image memory. The coordinate information defined on the model can be either two-dimensional plane coordinates as illustrated in FIG. 6 or three-dimensional spatial coordinates as illustrated in FIG. 7. In the display screen 7001 illustrated in FIG. 7, two predetermined regions 7005 and 7006 for displaying display objects are displayed. The embodiment illustrated in FIGS. 2 and 7 determines the distance from a position having coordinates 7002 corresponding to access request target data in a predetermined region 7005 of a display screen 7001, which is represented by data to be processed, to a position having coordinates 7004 represented by each image data stored in the read buffer. Then, image data, which is stored in the read buffer and corresponds to a position that is most distant from the position corresponding to access request target data to be newly read this time, is searched for and is overwritten.

Further, in a case where the processor performs processing, such as enlarged display/shrunk display, of data stored on the image memory, the coordinate information can be those obtained after the expansion/shrinkage of the data. In a case where the processor performs processing, such as the displaying of the screen at an offset position in a longitudinal or transversal direction from a position having coordinates represented by the data stored on the image memory, the coordinate information can be those obtained by being shifted to the offset position. Further, in a case where the processor performs processing, such as the rotational display of an image represented by the data stored on the image memory, the coordinate information can be those obtained after the rotation thereof is performed.

Further, the read buffer can be configured so that in a case where when the data stored on the image memory is read therefrom and the read data is transmitted to the processor and where the read data is simultaneously stored in the read buffer in step 3010, the coordinate information is stored in the read buffer together with the image data. Consequently, the conversion of addresses into coordinates in the calculation of the distance between a position corresponding to newly input access target data and a position corresponding to each data stored in the read buffer can be accelerated.

Furthermore, the read buffer access control portion can be configured so that when data, which is stored on the image memory is read therefrom, is transmitted to the processor and is simultaneously stored also in the read buffer in step 3010, the coordinate information corresponding to the image data is stored in the read buffer access control portion together with the image data by being associated with the image data. Consequently, the calculation of the distance between a position corresponding to newly input access target data and a position corresponding to each data stored in the read buffer can be accelerated.

Although the invention has been described in detail with reference to the specific embodiments, it is apparent to those skilled in the art that various changes and modifications can be made thereto without departing from the spirit and scope of the invention.

This patent application is based on the Japanese Patent Application No. 2006-136047 filed May 16, 2006, the disclosure of which is incorporated herein by reference.

### INDUSTRIAL APPLICABILITY

An image processing apparatus according to the invention has a mechanism for reducing the frequency of access to an external memory. The image processing apparatus according to the invention is useful as an image processing controller or the like for efficiently consuming electric power and using memory resources in a television apparatus having a liquid crystal screen, and a media recording/reproducing apparatus. In addition, the image processing apparatus according to the invention can be applied to the use such as a portable telephone and a portable information device.

1. An image processing apparatus comprising:
a processor which processes image data to be displayed on a display screen;
an image memory which stores image data that the processor processes;
a read buffer which is incorporated in a same semiconductor device including the processor, and stores, when the processor read image data from the image memory, the read data; and
a read buffer access control portion which controls a read buffer access such that when the processor processes processing target image data, the processor reads the processing target image data from the read buffer without reading the processing target image data from the image memory in a case where the read buffer includes the processing target image data, and the processor discards data stored in the read buffer and overwrites the discarded data with the processing target data read from the image memory in a case where the read buffer does not include the processing target image data, wherein
the read buffer access control portion is provided with a distance calculation portion,
in a case where the read buffer does not include the processing target image data, the distance calculation portion calculates a distance between a position having coordinates at which image data stored in the read buffer is displayed in a display region, and a position having coordinates at which the processing target image data is displayed in the display region, and
the read buffer access control portion controls a read buffer access to discard image data stored in the read buffer, which corresponds to the maximum one of the distances calculated by the distance calculation portion, and to overwrite the discarded image data with the processing target data read from said image memory.

2. The image processing apparatus according to claim 1, wherein the display region is the entire display area of the display screen.

3. The image processing apparatus according to claim 1, wherein the display region is a part of a display area of the entire display screen.

4. The image processing apparatus according to claim 3, wherein coordinates of positions displayed on the display region are three-dimensional spatial coordinates.

5. The image processing apparatus according to claim 1, wherein
the processor performs image processing to display on the display screen the image data stored in the image memory by expanding or shrinking the image data, and
the distance calculation portion calculates the distance using coordinates corresponding to the expanded or shrunk image data.

6. The image processing apparatus according to claim 1, wherein
the processor performs image processing such that image data stored in the image memory is displayed by setting an optional place in the display screen as a display starting point, and
the distance calculation portion determines the image data to be discarded, using coordinates of a position corresponding to the image data to be discarded in the display screen after the position corresponding to the image data to be discarded is moved to the display starting point.

7. The image processing apparatus according to claim 1, wherein
the processor performs image processing to display a position corresponding to image data stored in the image memory by rotating the image data stored in the image memory, and
the distance calculation portion determines the image data to be discarded, using coordinates of a position corresponding to the image data to be discarded in the display screen after rotation of the image data is performed.

8. The image processing apparatus according to claim 1, wherein when the image data stored in the image memory is stored in the read buffer, the read buffer access control portion holds, in the read buffer access control portion, coordinate information representing coordinates of a position corresponding to the image data to be stored in the read buffer.

9. The image processing apparatus according to claim 1, wherein when the image data stored in said image memory is stored in said read buffer, the read buffer access control portion causes the read buffer to store coordinate information representing coordinates of a position corresponding to the image data to be stored in said read buffer.
